(19) United States
(12) Patent Application Publication
(10) Pub. No.: US 2026/0344844 A1
(43) Pub. Date: Nov. 5, 2026

(54) ON-DEMAND CUSTOM INSOLES

(71) Applicant: Superfeet Worldwide LLC, Ferndale, WA (US)

(72) Inventors: Michael Sullivan, Ferndale, WA (US); Matthew Gooch, Ferndale, WA (US); Heather Allerdice-Gerow, Ferndale, WA (US)

(21) Appl. No.: 19/667,355

(22) Filed: May 4, 2026

Related U.S. Application Data
(60) Provisional application No. 63/800,211, filed on May 5, 2025.

(51) Int. Cl. A43B 17/00; A43B 17/16; A43D 1/02; B29C 64/386; B29L 31/50; B33Y 50/00; B33Y 80/00

(52) U.S. Cl. CPC A43B 17/006; A43B 17/16; A43D 1/025; B29C 64/386; B33Y 50/00; B33Y 80/00; B29L 2031/507

(57) ABSTRACT

Embodiments are directed to a method of a retailer providing a custom insole to a customer. The retailer has an inventory of pre-existing insole components and obtains foot shape data of the customer. Based on the foot shape data, the retailer obtains a pre-existing insole component from the inventory and 3D prints an insole component at or near the retailer. The retailer couples the pre-existing insole component to the printed insole component to provide a custom insole for the foot based on the foot shape data. Accordingly, the customer obtains the custom insole from the retailer faster than waiting for a non-retail manufacturing plant to manufacture and ship custom insoles to the customer.

### PRIORITY CLAIM

This application claims benefit of U.S. Provisional Application No. 63/800,211 entitled ON-DEMAND CUSTOM INSOLES filed May 5, 2025, the entire content of which is hereby incorporated herein by reference in its entirety.

### FIELD OF THE INVENTION

This application relates generally to providing custom insoles and, more particularly, to providing custom insoles at retailers.

### BACKGROUND OF THE INVENTION

Foot insoles and orthotics are often worn to provide customization to the fit of footwear. Podiatrists and shoe fitters provide custom insole and orthotics based the needs and preferences of a user. The process typically involves foot measurements, molds, or scans, after which an insole is created at another time and place based on the information collected. In particular, the information is typically sent to a manufacturer that makes and assembles the custom insole with complex machines and processes with sophisticated techniques that require high-skill labor of trained people dedicated to manufacturing before shipping it to the user. The user therefore typically waits days, if not weeks, to receive the custom insole resulting in continued discomfort during such period. Further, because of the labor costs associated with manufacturing and the associated shipping costs, a custom insole prepared by a manufacturer is often expensive for the user.

Other approaches to solve the problems include users selecting off-the-shelf insoles, but such insoles fail to be customized to meet the needs and preferences of the user. Off-the-shelf insoles often only approximate the foot of a user without providing an exact fit to a particular user. In some cases, the customer can partially mold the insole to the user's foot, but such approach inconveniences the user and fails if the user does not properly execute the molding process.

For these reasons, there is a need for speeding up the process for providing custom insoles. There is also a need for lowering the cost of providing custom insoles. There is a further need for lowering the complexity of providing custom insoles.

### SUMMARY OF THE INVENTION

It is therefore an object of the present invention to speed up the process for providing custom insoles.

It is also an object of the present invention to lower the cost of providing custom insoles.

It is a further object of the present invention to lower the complexity of providing custom insoles.

The invention achieves such object, as well as other objects and advantages that will become apparent from the description that follows, by a retailer providing a custom insole to a customer from a kit. An inventory of pre-existing insole components is provided to the retailer. The retailer obtains foot shape data of the customer's foot. Based on the foot shape data, the retailer obtains a pre-existing insole component from the inventory and 3D prints an insole component. The retailer couples the pre-existing insole component to the printed insole component to provide a custom insole for the customer, thereby facilitating providing the custom insole faster than waiting for a non-retail manufacturing plant to manufacture and ship custom insoles to the customer.

In some embodiments, characteristics information is also obtained from the customer, and the retailer obtains the pre-existing insole component from the inventory based on the characteristics information. 3D printing the insole component is preferably based on the characteristics information.

The pre-existing insole components preferably include one or more of an upper insole component, a heel outer cap, a forefoot cushion, or a heel cushion. The printed insole component preferably includes a heel inner cap or a heel stabilizer.

In some embodiments, an instruction is displayed to an employee of the retailer to select the pre-existing insole component based on the foot shape data. An instruction is preferably displayed to the employee for coupling the pre-existing insole component to the printed insole component. In some embodiments, the foot of the customer is scanned at the retailer to obtain the shape data.

### BRIEF DESCRIPTION OF THE DRAWINGS

Preferred and alternative examples of the present invention are described in detail below with reference to the following drawings.

FIG. 1 illustrates a schematic representation of a system for providing custom insoles at a retailer according to principles of the invention.

FIG. 2 is an exploded view of a first embodiment of a kit of components for a custom insole provided by the retailer of FIG. 1.

FIG. 3 is an exploded view of a second embodiment of a kit of components for a custom insole provided by the retailer of FIG. 1.

FIG. 4 is a bottom perspective view of a third embodiment of a kit of components for a custom insole provided by the retailer of FIG. 1.

FIG. 5 is a bottom perspective view of an upper insole component of the kit of components of FIG. 2.

FIG. 6 is a top perspective view of a heel inner cap of the kit of components of FIG. 3.

FIG. 7 is a bottom perspective view of a heel outer cap and a heel inner cap of the kit of components of FIG. 2.

FIG. 8 is a top perspective view of the heel inner cap and a heel outer cap of the kit of components of FIG. 2.

FIG. 9 is a bottom perspective view of the heel outer cap, a forefoot cushion, and a heel cushion of the kit of components of FIG. 2.

FIG. 10 is a top perspective view of a heel stabilizer of the kit of components of FIG. 2.

### DETAILED DESCRIPTION OF THE PREFERRED EMBODIMENTS

A kit to provide a custom insole at a retailer 30 in accordance with the principles of the invention is generally indicated at reference number 32 in the Figures of the attached drawings, wherein numbered elements in the Figures correspond to like numbered elements herein.

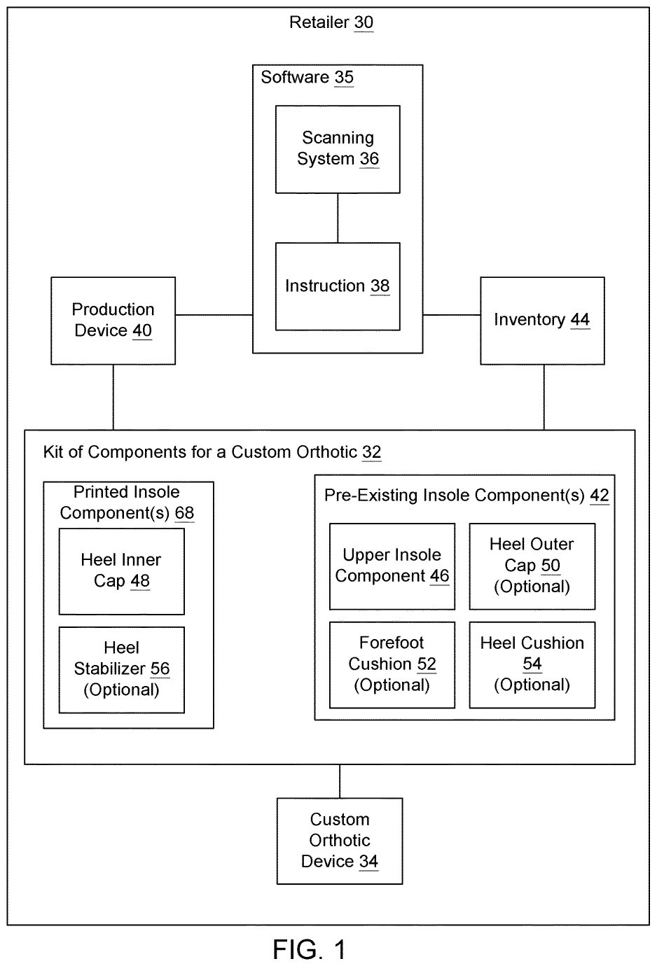

As shown in FIG. 1, a retailer 30 assembles a kit 32 to provide a custom insole 34 on demand on-site within a shorter amount of time to a customer of the retailer 30 than if the insole were manufactured at a manufacturing facility. The retailer 30 obtains foot shape data from the customer, such as a scan of the customer's foot conducted with a scanning system 36, and based on such data, instructions 38 for a custom insole for the customer are created for the retailer 30. A quick-turn production device 40 at the retailer 30, such as a three-dimensional printer or other additive or subtractive manufacturing device, generates or creates custom insole components based on the customer information. Preferably, only relatively small components of the overall custom insole are custom-made with small, lower-cost equipment that is on-site at the retailer 30 so that the production occurs quickly, such as while the customer waits or completes other shopping. The printed components are preferably designed to snuggly (e.g., friction fit or interference fit) with pre-existing components from the inventory to simplify how the components of the kit 32 couple to each other. The retailer 30 then couples the custom insole components with standard pre-existing insole components 42 selected from an inventory 44 at the retailer 30 to most closely match the needs or preferences of the customer. Accordingly, the custom production is limited while providing custom insoles that meet the medical or performance requirements or desires of the customer. The customer therefore obtains the custom insole 34 from the retailer 30 faster than waiting for a non-retail manufacturing plant to manufacture and ship custom insoles to the customer. By providing the custom insole 34 on-site at the retailer 30, the customer also has an opportunity to provide immediate feedback to achieve superior results for comfort and performance with potential modifications to the insole at the retailer 30.

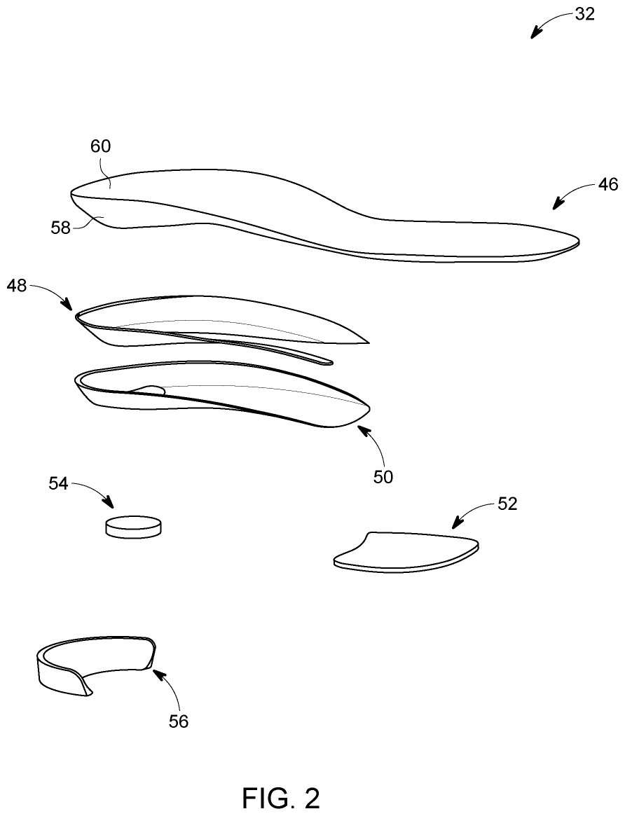

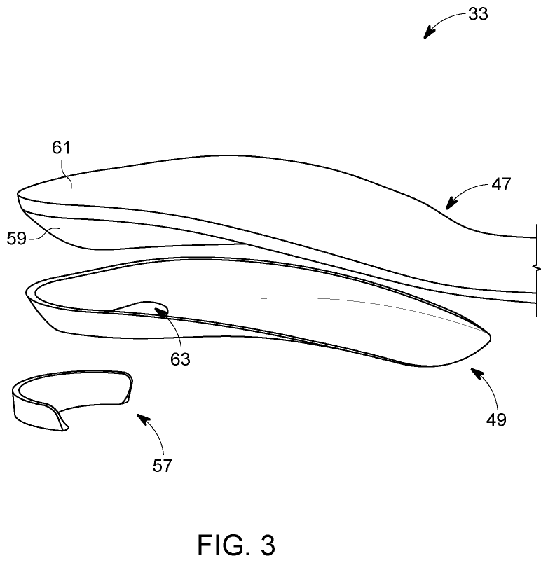

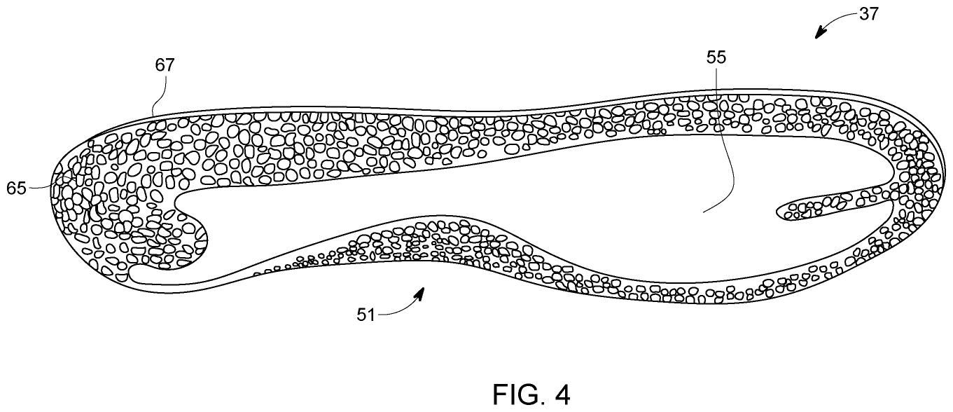

The components included in the custom insole 34 vary based on the characteristics or other preferences of the customer. As shown in FIGS. 1 and 2, a preferred kit of components 32 for a custom insole, such as the insole 34, includes an upper insole component 46, a heel inner cap 48, an optional heel outer cap 50, an optional forefoot cushion 52, an optional heel cushion 54, and an optional heel stabilizer 56. The components included in the custom insole 34 vary based on the characteristics of the customer, such as foot data or preferences. In an alternative embodiment of FIG. 3, a custom insole kit 33 includes an upper insole component 47 having a cushion layer 59 and a cover layer 61, a heel inner cap 49, and a heel stabilizer 57. In other embodiments, a kit of components includes an upper insole component 51 having a cushion layer 65 and a cover layer 67, and carbon fiber plate 57 such as those shown in FIG. 4 or in U.S. application Ser. No. 19/542,678 (Spring-Backed Footwear Insole, filed Feb. 18, 2026), which is hereby incorporated herein by reference.

As shown in FIG. 1, the retailer 30 preferably has an inventory of pre-existing components 42 that are paired with custom components 68 to provide a custom insole 34 to a customer. A scan of a customer's foot is conducted, such as with a scanner 36 (FIG. 1) at the retailer 30, to obtain foot data of the customer (e.g., foot length, arch height, or others). Optionally, the retailer obtains characteristics information from the customer (e.g., weight, gender, typical sports or activities during which the customer will have the insole in the customer's shoes). The collected information (e.g., foot data or characteristics information) is preferably relied upon to create instructions 38 for the employee of the retailer 30 to construct the custom insole 34 (FIG. 1). Optionally, the instructions 38 (FIG. 1) are displayed to the employee to select at least one pre-existing insole component 42 (FIG. 1) from the inventory 44 (FIG. 1). The employee selects the pre-existing insole component(s) 42 (FIG. 1) from the inventory 44 (FIG. 1) in response. The retailer 30 prints at least one custom insole component with a 3D printer or production device 40 (FIG. 1) at the retailer 30. Optionally, the instructions 38 (FIG. 1) for the custom insole 34 include information on how the employee couples the pre-existing insole component(s) 42 (FIG. 1) with the custom insole component(s) 68 (FIG. 1). This instruction 38 (FIG. 1) is preferably displayed to the employee of the retailer 30. The employee of the retailer 30 preferably couples the components to provide a custom insole 34 (FIG. 1) to the customer.

The retailer 30 preferably obtains the foot shape data at the retailer 30 from the customer such as taking photographs of the customer's foot, scanning the customer's foot, preparing foot molds, obtaining pressure measurements, or querying the customer. The retailer 30 obtains the foot shape data with a scanning system 36 in some embodiments (FIG. 1). In some embodiments, the scanning system 36 (FIG. 1) includes a mobile phone or tablet application that obtains such data based on one or more photographs of the customer's foot. In other embodiments, the scanning system 36 (FIG. 1) includes a device on which the customer steps to take size measurements and capture images.

Optionally, the foot shape data or customer characteristic data includes information regarding the customer's footwear to obtain information about a specific shoe into which the custom insole 34 (FIG. 1) will be inserted, such as specific models of footwear or categories of footwear, such as dress shoes, sports shoes, or others.

The retailer also optionally obtains characteristics information from the customer. The characteristics information preferably includes customer preferences, physical activity levels, or intended use of the custom insole 34 (FIG. 1). In some embodiments, the customer communicates the characteristics information to an employee of the retailer 30 or an electronic survey of the retailer 30.

As shown in FIG. 1, the scanning system 36 in some embodiments includes a software component 35 to provide and display instructions 38 to the employee of the retailer 30 regarding a kit 32 of specific components to gather or generate to create the custom insole 34. The instructions 38 (FIG. 1) provide assembly guidance to enable the employee, typically knowing little about manufacturing and with low training or skill, to create a custom insole 34 (FIG. 1). The instructions 38 (FIG. 1) identify the specific pre-existing insole components 42 (FIG. 1) to obtain from the inventory 44 (FIG. 1), the custom insole components 68 (FIG. 1) to generate with the production device 40 (FIG. 1), and information regarding coupling the selected and generated components to create the insole.

With the instructions 38 (FIG. 1) based on the foot shape data or characteristics information, the employee selects the pre-existing insole components 42 (FIG. 1) from the inventory 44 (FIG. 1) at the retailer 30 (FIG. 1). In one embodiment as shown in FIG. 2, the employee selects an upper insole component 46, a heel outer cap 50, a forefoot cushion 52, a heel cushion 54, and a heel stabilizer 56.

With the production device 40 (FIG. 1) at the retailer 30, the employee prints one or more custom components included in the instructions 38 (FIG. 1). In some embodiments as shown in FIG. 1, the software component 35 of the scanning system 36 sends instructions 38 directly to the production device 40 without employee intervention, such as with a selection of characteristics of the impending component, such as length, height, width, material, or others. The selection of components for personalizing the insole could go beyond the physical dimensions or characteristic insights gained from biometric data to include sport/activity or material-feel preferences of the athlete/consumer. Preferably, the instructions 38 (FIG. 1) provide that each 3D printed insole component 68 (FIG. 1) is shaped to interface with pre-existing components 42 (FIG. 1), regardless of customization by the customer, to facilitate simple assembly by the untrained employee, such as interference fit, friction fit, or others.

The production device 40 (FIG. 1) is preferably a desktop 3D printer rather than an industrial scale printer and facilitates simplified operation by the employee. In some embodiments, the employee prints a custom heel inner cap 48 (FIG. 2) or a custom heel stabilizer 56 (FIG. 2). Because of the relative size of these components compared to other components of the custom insole 34 (FIG. 1), the components can print quickly to allow for quick production and assembly.

Once all components are obtained and printed to thereby provide the kit, the employee of the retailer 30 couples the components to create the custom insole 34 (FIG. 1). Preferably, the employee couples the components with an adhesive such as a rubberized cement. In some embodiments, the adhesive is pre-applied to pre-existing insole components 42 (FIG. 1) with a film or similar barrier layer disposed atop the adhesive to maintain the adhesive prior to coupling.

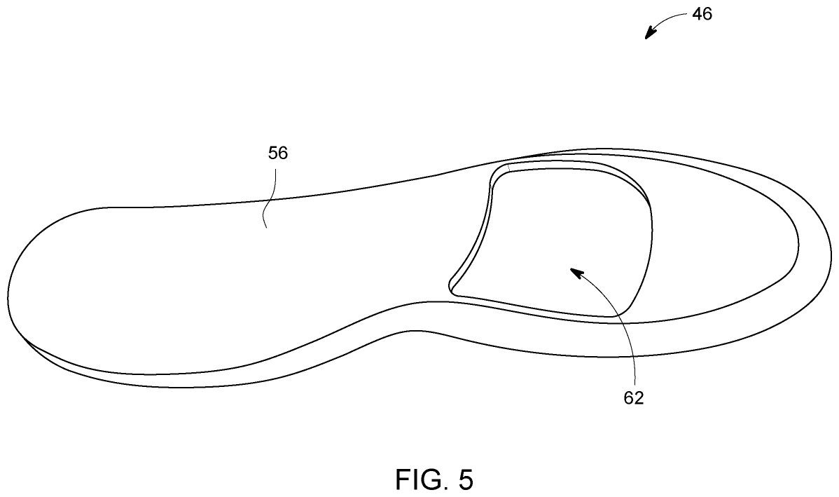

In a preferred embodiment, the employee of the retailer couples a custom insole 34 as shown in FIG. 2 having an upper insole component 46, a heel inner cap 48, a heel outer cap 50, a forefoot cushion 52, a heel cushion 54, and a heel stabilizer 56. The employee couples the upper insole component 46 (FIG. 2) to the heel inner cap 48 (FIG. 2) by applying the adhesive to the exposed cushion layer 58 (FIG. 2) of the upper insole component 46 (FIG. 2) or the concave side of the heel inner cap 48 (FIG. 2) and applying pressure to join the components. To secure the heel inner cap 48 (FIG. 2) to the heel outer cap 50 (FIG. 2), the employee removes the barrier layer from the concave side of the heel outer cap 50 (FIG. 2) and secures the heel outer cap 50 (FIG. 2) to the heel inner cap 48 (FIG. 2). To couple the forefoot cushion 52 (FIG. 2) to the custom insole 34 (FIG. 1), the employee of the retailer 30 preferably removes the barrier layer from the forefoot cushion 52 (FIG. 2) and inserts the components into the recess of the upper insole component 62 (FIG. 5). Finally, the employee applies adhesive to the concave side of the heel stabilizer 56 (FIG. 2) or convex side of the heel outer cap 50 (FIG. 2) to couple the heel stabilizer 56 (FIG. 2) to the custom insole 34 (FIG. 1).

Once coupled, the employee of the retailer optionally perform quality assurance actions to ensure the custom insole 34 (FIG. 1) is properly assembled. Quality assurance actions include verifying the fit of the custom insole 34 (FIG. 1) with the customer, testing the custom insole 34 (FIG. 1) for fit in a customer's shoe, or examining the custom insole 34 (FIG. 1) for gaps between any components. Preferably, the time between obtaining the foot shape data and providing the customer with the final custom insole 34 (FIG. 1) is one hour providing a key advantage over custom insoles assembled by a manufacturer.

FIGS. 2, 3, and 5 show preferred upper insole components 46. The upper insole 46 preferably has a cushion layer 58 and a cover layer 60. The upper insole 46 is preferably an off-the-shelf part kept in inventory 44 at the retailer 30 in several sizes to enable an employee of the retailer 30 to select the size that fits closest to the foot of the customer.

The cushion layer 58 of the upper insole component 46 is selected based on the level of plushness, support, and breathability desired for the comfort and intended use of the custom insole 34. Thus, in some embodiments, a firmer or stiffer material is selected for the cushion layer 58 of the upper insole component 46 based on the customer's characteristics. In other embodiments, a more supportive material is employed at the heel end of the cushion layer 58 or the toe end of the cushion layer 58. In some embodiments, the cushion layer 58 is closed-cell or open-cell foam or with small holes in the foam. The foam preferably includes a recess 62 under the region of the ball of the foot to accommodate a forefoot cushion 52 to further customize the upper insole component 46. The foam may be a closed-cell polyethylene but may be other closed-cell or open-cell foam or other materials. Other cushion materials include generative designed structures or multi-material parts. FIG. 3 illustrates another embodiment of the cushion layer 59.

The optional cover layer 60 is coupled to the cushion layer 58 of the upper insole component 46. The cover layer 60 is a thin, solid, and flexible material such as a composite or fabric. The cover layer 60 provides a different density of padding than the cushion layer 58, breathability, and a smooth slidable surface to ease entry of the customer's foot into the custom insole 34. In embodiments with the cover layer 60, graphics providing information about the custom insole 34 are optionally printed atop the cover layer 60. FIG. 3 illustrates another embodiment of the cover layer 61.

Both the cushion layer 58 and the cover layer 60 of the upper insole component 46 are off-the-shelf components provided in the inventory 44. In some embodiments, the cover layer 60 is applied to the cushion layer 58 at the retailer 30 by an employee of the retailer 30 with adhesives that are simple to apply without specialized training or skill, such as an adhesive pre applied to pre-existing insole components 42 with a film or similar barrier layer disposed atop the adhesive to maintain the adhesive prior to removal of the barrier and thus facilitating simplified coupling of the custom component. In other embodiments, the cover layer 60 is pre-applied to the cushion layer 58 prior to arrival at the retailer 30.

In some embodiments, the custom insole 34 includes a custom printed heel inner cap 48 coupled to the cushion layer 58 of the upper insole component 46. The heel inner cap 48 preferably includes a polymer such as nylon, acrylonitrile butadiene styrene (ABS) plastic, or polylactic acid (PLA) plastic.

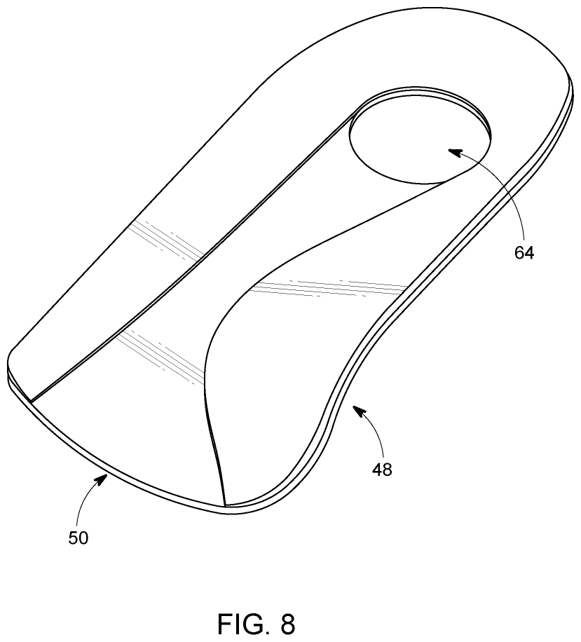

The heel inner cap 48 extends from a customer's heel to the ball of the foot when in use. In the embodiments of FIGS. 2 and 8, the heel inner cap 48 is u-shaped to provide a custom heel cup, arch support, and outer side shaping without support underneath the arch of customer's foot when in use.

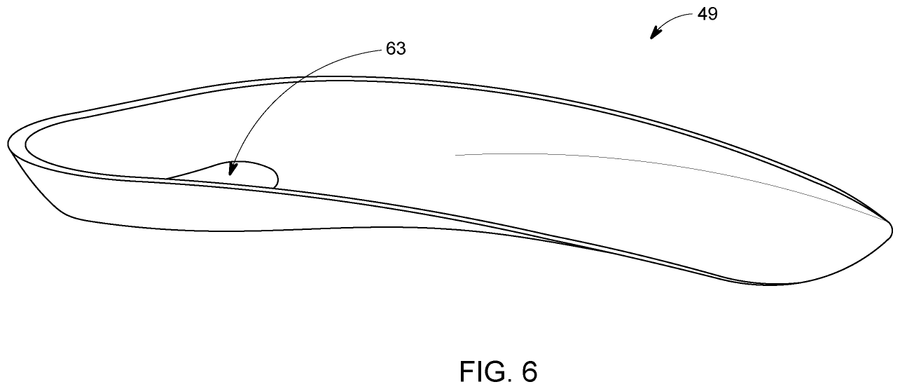

In other embodiments shown in FIGS. 3 and 6, a heel inner cap 49 provides support underneath the arch of customer's foot when in use. In such embodiments, a heel outer cap is optionally omitted from the custom insole. Optionally, the heel inner cap 49 includes an aperture 63 to secure a separate heel cushion 54 to the custom insole 34.

The custom insole 34 optionally includes a heel outer cap 50. The heel outer cap 50 provides support for the heel inner cap 48. The heel outer cap 50 is preferably an off-the-shelf part kept in inventory 44 at the retailer 30 in several sizes to select the size that fits closest to the foot of the customer. Because the heel outer cap 50 provides support for the heel inner cap 48, a custom insole 34 preferably includes an heel outer cap 50 to reduce the amount of material to be printed to form the heel inner cap 48, reducing the wait time for a customer at a retailer. Preferably, the heel outer cap 50 is sized and dimensioned to match the heel inner cap 48.

If manufactured by additive printing, the heel outer cap 50 is preferably a polymer such as nylon, acrylonitrile butadiene styrene (ABS) plastic, or polylactic acid (PLA) plastic. If manufactured by other processes, the heel outer cap 50 is preferably cork, compression molded parts, CNC machined parts, or thermoformed parts.

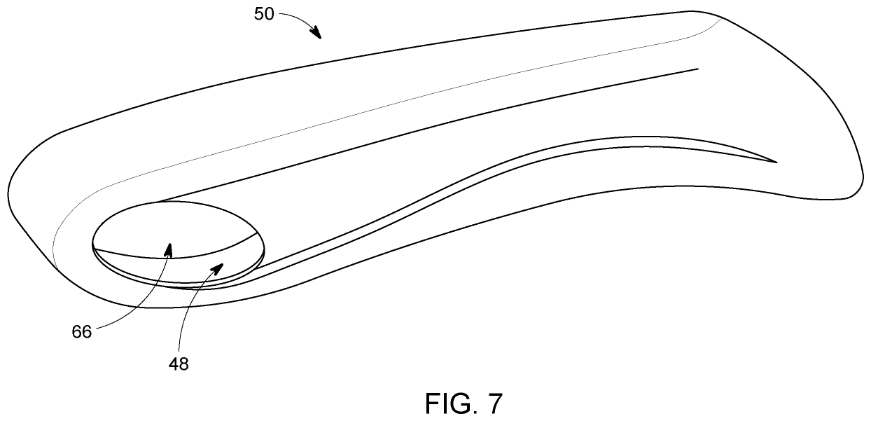

As shown in FIGS. 2, 7, and 8, the heel outer cap 50 forms a blank of a foot to provide structure to the custom insole 34. The off-the-shelf heel outer cap 50 accommodates most custom insoles while preserving space for a custom heel inner cap 48. In some embodiments, the heel outer cap 50 extends only from a customer's heel to the ball of the foot.

The outer face of the heel outer cap 50 is shaped to accommodate insertion into generic footwear, preferably with a lower flat face along at least a portion thereof to provide general stability as shown in FIG. 8. Alternatively, the outer cap may be sized for specific footwear or even custom quick-turn produced to fit into the specific user footwear, even if the footwear is not new. A geometry library may be used to custom tune the heel outer cap 50 or a combined heel inner cap 48 and heel outer cap 50 to match a specific model of footwear. The library refers to a library of footwear internal geometry data (e.g., the 3D interior measurements of footwear). In some embodiments, the heel outer cap 50 includes an aperture 66 to secure a separate heel cushion 54 to the custom insole 34.

In some embodiments, the heel inner cap 48 and the heel outer cap 50 are integrated into a unitary structure of a single component.

The custom insole 34 optionally includes a forefoot cushion 52. The forefoot cushion 52 provides further customization to the custom insole 34 without further custom printed components 68. The forefoot cushion 52 is preferably an off-the-shelf part kept in inventory 44 in several sizes to select the size that fits closest to the foot of the customer. The forefoot cushion 52 is preferably a foam, gel, or closed-cell polyethylene. Other forefoot cushion 52 materials include generative designed structures or multi-material parts, such as in either case produced by a 3D printer at the retailer 30. In some embodiments, the material of the forefoot cushion 52 has a different hardness than the material of the cushion layer 58 of the upper insole component 46.

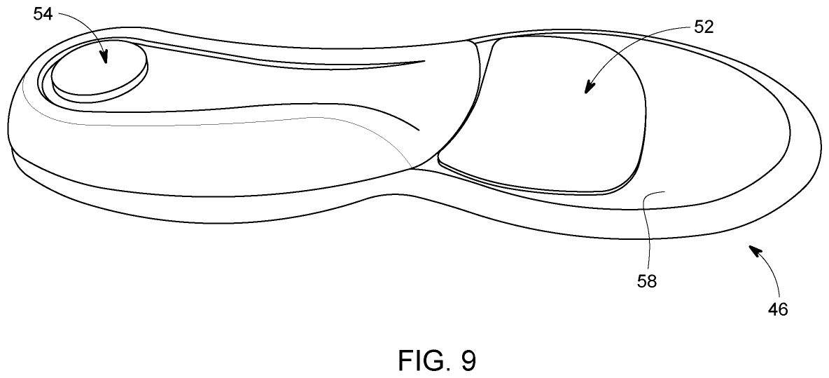

As shown in FIG. 9, the forefoot cushion 52 is coupled to the cushion layer 58 of the upper insole component 46 at the recess 62 of the upper insole component 46.

The custom insole 34 optionally includes a heel cushion 54. The heel cushion 54 provides further customization to the custom insole 34 without further custom printed components 68. The heel cushion 54 is preferably an off-the-shelf part kept in inventory 44 at the retailer 30 in several sizes to select the size that fits closest to the foot of the customer. The heel cushion 54 is preferably a foam, gel, or closed-cell polyethylene. Other heel cushion 54 materials include generative designed structures or multi-material parts. In some embodiments, the material of the heel cushion 54 has a different hardness than the material of the cushion layer 58 of the upper insole component 46.

As shown in FIG. 9, the heel cushion 54 is inserted into the recess 66 of the heel outer cap 50.

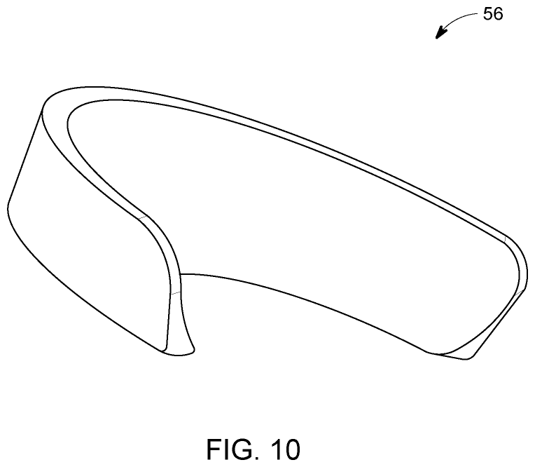

The custom insole 34 optionally includes a heel stabilizer 56. The heel stabilizer 56 provides support to a customer's heel and is tailored based on the intended use of the shoe. Custom heel stabilizers are quick-turn 3D printed or optionally pulled from off-the-shelf inventory 44 of the retailer to better stabilize the cap within a particular shoe of a customer. Because of its small size, custom heel stabilizers are preferably 3D printed to provide further customization to the customer. FIG. 10 shows an embodiment of a heel stabilizer 56 that is preferably u-shaped to conform to the heel of customer. The heel stabilizer 56 includes an inner surface contoured to couple with the heel outer cap 50 or upper insole component 46.

The material of the stabilizer is selected based on the intended use of the footwear, such as dress shoe, basketball shoe, or others. The heel inner cap 48 is preferably a polymer such as nylon, acrylonitrile butadiene styrene (ABS) plastic, or polylactic acid (PLA) plastic.

The term “retailer” as used herein a person or business that sells goods to the public or a retail store of such person or business.

The term “near” refers to within 5 miles, 2 miles, 1 miles, 0.5 miles, 1 city block, adjacent premises, on the same premises, or having the same address or parcel number of the identified location such as a retailer. The term “or” is an inclusive grammatical conjunction to indicate that one or more of the connected terms may be employed. For example, the phrase “one or more A, B, or C” or the phrase “one or more As, Bs, or Cs” is employed to discretely disclose each of the following: i) one or more As, ii) one or more Bs, iii) one or more Cs, iv) one or more As and one or more Bs, v) one or more As and one or more Cs, vi) one or more Bs and one or more Cs, and vii) one or more As, one or more Bs, and one or more Cs. The term “based on” as used herein is not exclusive and allows for being based on additional factors not described. The articles “a,” “an,” and “the” include plural references. Plural references are intended to also disclose the singular.

While the preferred embodiments of the invention have been illustrated and described, as noted above, many changes can be made without departing from the spirit and scope of the invention. Each disclosure of a component preferably having a feature or characteristic is intended to also disclose the component as being devoid of that feature or characteristic, unless the principles of the invention clearly dictate otherwise. Accordingly, the scope of the invention is not limited by the disclosure of the preferred embodiment. Instead, the invention should be determined entirely by reference to the claims that follow. It should also be noted that the claim dependencies or combinations of elements recited in the claims do not reflect an intention to forgo claiming other subject matter disclosed herein. Instead, this disclosure is intended to also disclose the subject matter of any combination of any two or more of the claims, such that subsequent claim sets may recite that any one of the dependent claims depends from any other one or more claims, up to and including all other claims in the alternative (such as “The apparatus or method of any one of the preceding or subsequent claims . . . ”). This disclosure is also intended to disclose the subject matter of any one of the dependent claims, as if it were an independent claim, with or without all or a portion of the subject matter of the original independent claim(s) or any other subject matter disclosed herein.

Those of ordinary skill in the art will conceive of other alternate embodiments of the invention upon reviewing this disclosure. Thus, the invention is not to be limited to the above description but is to be determined in scope by the claims that follow.

The embodiments of the invention in which an exclusive property or privilege is claimed are defined as follows:

1. A method of providing a custom insole, comprising:
providing an inventory of pre-existing insole components to a retailer of insoles;
obtaining foot shape data of a customer of the retailer;
based on the foot shape data, obtaining a pre-existing insole component from the inventory at the retailer;
based on the foot shape data, 3D printing a insole component at or near the retailer; and
at or near the retailer, coupling the pre-existing insole component to the printed insole component to provide the custom insole for the foot based on the foot shape data,
whereby coupling the pre-existing insole component to the printed insole component at or near the retailer facilitates the customer obtaining the custom insole from the retailer faster than waiting for a non-retail manufacturing plant to manufacture and ship custom insoles to the customer.

2. The method of claim 1, further comprising obtaining characteristics information from the customer, wherein obtaining the pre-existing insole component from the inventory includes selecting the pre-existing insole component based on the characteristics information.

3. The method of claim 1, further comprising obtaining characteristics information from the customer, wherein 3D printing the insole component is based on the characteristics information.

4. The method of claim 1, wherein the pre-existing insole component includes an upper insole component.

5. The method of claim 1, wherein the pre-existing insole component includes two or more of an upper insole component, a heel outer cap, a forefoot cushion, or a heel cushion.

6. The method of claim 1, wherein the printed insole component includes a heel inner cap.

7. The method of claim 1, wherein the printed insole component includes a heel stabilizer.

8. The method of claim 1, wherein the printed insole component includes a heel inner cap and a heel stabilizer.

9. The method of claim 1, further comprising displaying to an employee of the retailer an instruction to select the pre-existing insole component based on the foot shape data.

10. The method of claim 1, further comprising displaying to an employee of the retailer an instruction on coupling the pre-existing insole component to the printed insole component.

11. The method of claim 1, wherein obtaining foot shape data of the customer of the retailer includes scanning the foot of the customer at or near the retailer.

12. A kit for a custom insole for a foot, comprising:
a pre-existing insole component obtained from an inventory of pre-existing insole components based on foot shape data of a customer of the retailer; and
a 3D printed insole component printed at or near the retailer based on the foot shape data, wherein the pre-existing insole component and the 3D printed insole component are sized and dimensioned to couple together based on the foot shape data to form a custom insole,
whereby the pre-existing insole component and the 3D printed insole component are sized and dimensioned to couple together based on the foot shape data to form a custom insole facilitates the customer obtaining the custom insole from the retailer faster than waiting for a non-retail manufacturing plant to manufacture and ship custom insoles to the customer.

13. The kit of claim 12, further comprising:
a pre-existing upper insole component;
a pre-existing heel outer cap;
a 3D printed heel inner cap;
a pre-existing forefoot cushion;
a pre-existing heel cushion; and
a 3D printed heel stabilizer.

14. The kit of claim 12, wherein the pre-existing insole component is obtained based on the characteristics information from the customer.

15. The kit of claim 12, wherein the 3D printed insole component is printed at or near the retailer based on characteristics information from the customer.

16. The kit of claim 12, wherein the pre-existing insole component includes an upper insole component.

17. The kit of claim 12, wherein the pre-existing insole component includes two or more of an upper insole component, a heel outer cap, a forefoot cushion, or a heel cushion.

18. The kit of claim 12, wherein the printed insole component includes a heel inner cap.

19. The kit of claim 12, wherein the printed insole component includes a heel stabilizer.

20. The kit of claim 12, wherein the printed insole component includes a heel inner cap and a heel stabilizer.
